(19) United States
(12) Patent Application Publication
(10) Pub. No.: US 2006/0147039 A1
(43) Pub. Date: Jul. 6, 2006

(54) Data encryption method cryptographic system and associated component

(75) Inventors: Jean-Sebastien Coron, Paris (FR); Marc Joye, Saint Zacharie (FR); David Naccache, Paris (FR); Pascal Paillier, Paris (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: GEMPLUS, Gemenos (FR)

(21) Appl. No.: 10/522,420

(22) PCT Filed: Jul. 25, 2003
(86) PCT No.: PCT/FR03/02364

§ 371 Date: Jul. 26, 2005

(30) Foreign Application Priority Data
Jul. 26, 2002 (FR) 02/09475

(51) Int. Cl. H04L 9/28

(52) U.S. Cl. 380/28

(57) ABSTRACT

An encryption method in which a clear message (m) is formatted with a formatting function (p), and in which the result of the formatting step is exponentiated using a public key (N, e) in accordance with the relationship c=μ(m)^{e} mod N, c being an encrypted message, μ(m) being the result of the formatting step, and e and N elements of the public key. The formatting function (μ) is the PSS function. The invention is applicable to cryptography, for example of RSA type, for smart cards for instance.

The invention concerns an enciphering method, and an associated cryptographic system, with application in particular in the field of public-key cryptography. The invention can be implemented in electronic devices such as chip cards.

A complete public-key cryptographic system generally comprises an enciphering algorithm and a signature algorithm. Such a cryptographic system can be implemented for example in a chip card comprising in particular, in an integrated circuit, calculation means programmed to implement the algorithms, and storage means for storing the public keys and/or secret keys necessary for implementing the algorithms.

A known algorithm used in public-key cryptographic systems is the RSA algorithm (from Rivest, Shamir and Adleman). It can be used for performing enciphering operations and signature operations. In general terms, the RSA algorithm consists of performing an operation of exponentiation, by means of a public or private key, of a message in clear formatted by means of an enciphering function or a signature function, according to circumstances.

An enciphering method using the RSA algorithm thus consists of formatting a message in clear m by means of an enciphering function A, and then performing an exponentiation of the result in accordance with the equation
C=f(μ(m))=[μ(m)]^{e}mod N
where μ is an enciphering function, (N, e) a public key, and f(x, N, e) the exponentiation function f(x, N, e) =x^{e} mod N.

The enciphered message c can then be deciphered using once again the RSA algorithm, with the inverse function f⁻¹ (x, N, d) being a private key associated with the public key (N, e).

A signature method using the RSA algorithm consists in a similar manner of formatting a message in clear m by means of a signature function μ′ and then performing an exponentiation of the result in accordance with the equation:
s=f⁻¹[μ′(m)]=[μ′(m)]^{d′} mod N′

when μ is a signature function, (N′, d) a private key, and f⁻¹ (x, N′, d′) the exponentiation function f⁻¹ (x, N′, d′)=x^{d′} mod N′.

The signature can then be verified once again using the RSA algorithm, with the inverse function f(x, N′, e′), (N′, e′) being a public key associated with the private key (N′, d′).

The exponentiation functions and the enciphering or signature functions used in the cryptographic systems are in general known. The security of the encrypting systems therefore depend solely on the private and public keys used, which it is essential to keep concealed.

The security thus depends in particular on the size of the keys, which are chosen so as to be large. The numbers N, N′ are generally of large size, for examples 1024 bits, they are equal to the product of two prime numbers N=p*q, N′=p′*q′. The integer numbers d, d′ depend on the numbers N, N′ and are also of large size. The integer numbers e, e′ are on the other hand often of small size.

For reasons of security, the keys ((N, e); (N, d) used for the enciphering and the keys ((N′, e′); (N′, d′)) used for the signature are different.

A signature function μ′ is said to be secure if it is not possible to create a signature s of a message m without knowing the private key, even if signatures s1, s2 of message m1, m2 are known. The functions μ′ used in the cryptographic systems are constructed in order to satisfy this condition.

A known function μ′ which is secure for signature operations is the PSS (Probabilistic Signature Scheme) function, described in particular in document D1 (M. Bellare and P. Rogaway, The exact security of digital signatures—How to sign with RSA, and Rabin, Proceedings of Eurocrypt '96, LNCS vil 1070, Springer-Verlag, 1996, pp 399-416) and in the standard PKCS#1 v2.1, RSA Cryptography Standard.

The PSS function is parameterised by integers k, k0, k1 and uses two hashing functions:
H:{0, 1}^{k-k1}→{0, 1}^{k1}
G:{0, 1}^{k1}→{0, 1}^{k-k1}

From a text in clear m of k−k0−k1 bits and a random number r of k0 bits, the function PSS produces:
PSS(m, r)=ω||s

with r a random parameter associated with the function PSS, || the concatenation function, ω=H(m ||r), s=G (ω) ⊕(m||r), and ⊕ the logic function XOR.

The signature s of the message m is then obtained by exponentiation by means of the secret key (N, d):
S=f([PSS(m, r)], N, d)=[PSS(m, r)]^{d}mod N

A signature s can be verified by calculating:
f⁻¹(s)=s^{e}mod N=ω||s

where f⁻¹ is the inverse function of the exponentiation function f.

Knowing the size of ω and s (respectively k1 bits and k−k1 bits), ω and s are deduced from f⁻¹(s)·G(ω) ⊕ s is calculated from ω, s and G. As G(ω) ⊕ s=M||r, H(m||r) and m are deduced from this in the end. Finally, ω and H(m||r) are compared. If H(m||r)=ω, then the text in clear m is returned, otherwise only an error message is sent back.

In a similar manner, an enciphering function μ is said to be secure if it is not possible to distinguish two enciphered messages c1, c2 obtained from the function μ and two messages in clear m1, m2, even if one of the associated messages in clear m1 or m2 is known. The functions μ used in the crytographic systems are constructed so as to satisfy this security condition.

However, because the security criteria are not the same for signature operations and enciphering operations, the signature functions μ′ and the enciphering functions μ are not the same.

Consequently, in order to implement a complete cryptographic system, able to encipher and decipher, it is necessary to have means for storing two different functions, more generally two different algorithms, and to have different programmed calculation means for implementing them. The size of the resulting electronic circuit is obviously proportional to the size of the algorithms to be stored.

To resolve the problem mentioned above, according to the invention, one and the same formatting function is used, both as an enciphering function and as a signature function. More precisely, according to the invention, in order to implement an enciphering method, the PSS function is used, known moreover for implementing a signature method.

Thus the invention concerns an enciphering method comprising a step of formatting a message in clear by means of a formatting function, and a step of exponentiation of the result of the previous step by means of a public key in accordance with the equation c=μ(m)^{e} mod N, c being an enciphered message, μ(m) being the result of the formatting step, and e and N elements of the public key.

According to the invention, the formatting function is the PSS function.

The PSS function is a secure function for enciphering operations. This is because it is shown that the PSS function is secure for enciphering operations, in the random oracle model, as defined in D2: M Bellare and P Rogaway, Random oracles are practical: a paradigm for designing efficient protocols. Proceedings of the First Annual Conference on Computer Communication Security, ACM, 1993. Moreover, currently in the field of cryptography, the concept of security in the random oracle model and the concept of the highest security for real applications.

Thus, according to the invention, there is available a secure function both for signature and enciphering operations.

The invention also concerns a cryptography system comprising an enciphering method and a signature method, both using the PSS function as a formatting function.

More precisely, the cryptographic system comprises:
a step of formatting a message in clear by the probabilistic signature function (PSS), and then:
if an enciphering of the message in clear is required, a step of exponentiation of the result of the formatting step by means of a first key in accordance with the equation c=μ(m)^{e} mod N, c being an enciphered message, μ(m) being the result of the formatting step, and e and N elements of the first key, or
if a signature of the message in clear is required, a step of exponentiation of the result of the formatting step by means of a second key (N′, d′) in accordance with the equation s=μ(m) d′ mod N′, s being a signed message, μ(m) being the result of the formatting step, and d′ and N′ elements of the second key.

Such a cryptographic system is advantageous compared with known cryptographic systems since it requires approximately half the means (in terms of programmed calculation means and memory space in particular) in order to be implemented.

According to one embodiment, the first key and the second key are respectively a public key of a first pair of keys and a private key of a second pair of keys.

According to another, preferred, embodiment the first pair of keys and the second pair of keys are identical. In other words, the same set of keys is used, for implementing both the enciphering method and the signature method. It is shown in fact that deciphering a message, enciphered according to an enciphering method using the PSS function and a given set of keys, does not make it possible to obtain sufficient information for signing a message (possibly the deciphered message) according to a signature method using the PSS function and the same set of keys. Symmetrically, it is shown that obtaining information on the signature of a signed method, according to a signature method using the PSS function and a given set of keys, does not make it possible to obtain information on a message in clear enciphered according to an enciphering method using the same PSS function and the same set of keys.

The invention is in particular applicable to the RSA cryptography algorithm, which is the algorithm mostly used at the present time in the field of cryptography.

The invention also concerns an electronic component comprising means programmed for implementing an enciphering method as described above, using the PSS function as a formatting function. The programmed means comprise in particular a central unit and a program memory.

The invention also concerns an electronic component comprising programmed means for implementing a cryptographic system as described above, comprising an enciphering operation or a signature operation, executed alternately. The programmed means comprising in particular a central unit and a program memory.

The invention is in particular advantageous for applications of the chip card type, in which the components used must be of the smallest possible size, and implementation of the methods which is as rapid as possible.

1. An enciphering method comprising a step of formatting a clear message (m) by means of a formatting function (μ), and a step of exponentiation of the result of the previous step using a public key (N, e) in accordance with the equation c=μ(m)^{e} mod N, c being an enciphered message, μ(m) being the result of the formatting step, and e and N elements of the public key,
wherein the formatting function (μ) is the PSS function.

2. A method according to claim 1, wherein the formatting function μ is defined by
μ(m)=PSS(m)=ω||s, with:
m, the clear text of k−k0−k1 bits, r a random parameter of k0 bits, k, k0, k1 being parameters of the formatting function,

|| a concatenation function
ω=H(m||r)
s=G(ω)⊕(m||r)
⊕ a logic function XOR, and
H, G two hashing functions

3. A method of enciphering a message using a probabilistic signature function defined according to the standard PKCS #2 v 2.1, RSA cryptography standard as a formatting function (μ), comprising a step of formatting a clear message (m) by means of the formatting function (μ), and a step of exponentiation of the result of the previous step by means of a public key (N, e) in accordance with the equation c=μ(m)^{e} mod N, c being an enciphered message, μ(m) being the result of the formatting step, and E and N elements of the public key.

4. A cryptographic method comprising:
a step of formatting a clear message (m) by the probabilistic signature function, and then:
if an enciphering of the clear message (m) is required, a step of exponentiation of the result of the formatting step by means of a first key (N, e) in accordance with the equation c=μ(m)^{e} mod N, c being an enciphered message, μ(m) being the result of the formatting step, and e and N elements of the first key, or
if a signature of the clear message (m) is required, a step of exponentiation of the result of the formatting step by means of a second key (N′d′) in accordance with the equation s=μ(m)^{d′} mod N′, s being a signed message, μ(m) being the result of the formatting step, and d′ and N′ elements of the second key.

5. A method according to claim 4, in which the first key and the second key are respectively a public key of a first pair of keys and a private key of a second pair of keys.

6. A method according to claim 5, in which the first pair of keys and the second pair of keys are identical.

7. A method according to claim 4, in which the enciphering is of the RSA type.

8. An electronic component comprising a programmed processor for implementing an enciphering method according to claim 1, the programmed processor comprising a central unit and a program memory.

9. An electronic component comprising a programmed processor for implementing a cryptographic method according to claim 4, the programmed processor comprising a central unit and a program memory.

10. A chip card comprising an electronic component according to claim 8.

11. A chip card comprising an electronic component according to claim 9.
